(19) United States
(12) Patent Application Publication
(10) Pub. No.: US 2015/0214837 A1
(43) Pub. Date: Jul. 30, 2015

(54) CHARGE PUMP CIRCUIT

(71) Applicant: LAPIS SEMICONDUCTOR CO., LTD., Kanagawa (JP)

(72) Inventor: Junya OGAWA, Kanagawa (JP)

(21) Appl. No.: 14/601,324

(22) Filed: Jan. 21, 2015

(30) Foreign Application Priority Data
Jan. 29, 2014 (JP) 2014-014385

(51) Int. Cl. H02M 3/07

(52) U.S. Cl. CPC H02M 3/07

(57) ABSTRACT

A charge pump circuit includes a first potential input terminal for receiving a first potential; a second potential input terminal for receiving a second potential; a pump cell group formed of a plurality of pump cells and connected in series between the first potential input terminal and the second potential input terminal; and a negative voltage boosting capacitor connected to a first connection node between the first potential input terminal and a forefront stage pump cell of the pump cell group. Each of the pump cells is configured to increase a boosted voltage using a transistor operating in synchronization with a clock signal input through a capacitor.

### BACKGROUND OF THE INVENTION AND RELATED ART STATEMENT

The present invention relates to a charge pump circuit. In particular, the present invention relates to a charge pump circuit for increasing a power source voltage.

In a non-volatile semiconductor storage device that electrically write and delete data, when data is written or deleted, a positive boosted voltage or a negative boosted voltage greater than a power source voltage is applied to a memory cell of the non-volatile semiconductor storage device. More specifically, a high positive boosted voltage is applied when data is written in the memory cell, for example, and a high negative boosted voltage is applied when data is deleted from the memory cell. A conventional high voltage generating circuit using a charge pump has been proposed for generating the high positive boosted voltage and the high negative boosted voltage.

Patent Reference 1 has disclosed such a conventional high voltage generating circuit using a conventional charge pump. In the conventional high voltage generating circuit disclosed in Patent Reference 1, two switches are switched between an on state and an off state thereof, so that the conventional high voltage generating circuit generates the high positive boosted voltage and the high negative boosted voltage.

Patent Reference 2 has disclosed another conventional high voltage generating circuit using another conventional charge pump. In the conventional high voltage generating circuit disclosed in Patent Reference 2, a PMOS transistor and a NMOS transistor are switched between an on state and an off state thereof, so that the conventional high voltage generating circuit generates the high positive boosted voltage and the high negative boosted voltage.

Patent Reference 1: Japanese Patent Publication No. 09-198887

Patent Reference 2: Japanese Patent Publication No. 07-177729

In the conventional high voltage generating circuits disclosed in Patent References 1 and 2, the conventional charge pump is formed of one single circuit that generates both the high positive boosted voltage and the high negative boosted voltage. However, the conventional charge pump tends to generate the high negative boosted voltage having an absolute value smaller than that of the high positive boosted voltage. More specifically, the conventional charge pump is capable of obtaining only the negative boosted voltage having an absolute value smaller than that of the high positive boosted voltage.

Accordingly, when the conventional charge pump is designed to be capable of obtaining the negative boosted voltage having a desired absolute value, the absolute value of the positive boosted voltage output from the conventional charge pump tends to become unnecessarily large. On the other hand, when the conventional charge pump is designed to be capable of obtaining the positive boosted voltage having a desired absolute value, the absolute value of the negative boosted voltage output from the conventional charge pump tends to become insufficient. In this case, it is necessary to provide a separate negative voltage generating circuit.

In view of the problems of the conventional charge pump circuit described above, an object of the present invention is to provide a charge pump circuit capable of outputting a negative boosted voltage having a sufficient absolute value. Further, it is possible to minimize a boosted voltage difference between absolute values of the positive boosted voltage and the negative boosted voltage.

Further objects and advantages of the invention will be apparent from the following description of the invention.

### SUMMARY OF THE INVENTION

In order to attain the objects described above, according to an aspect of the present invention, a charge pump circuit includes a first potential input terminal for receiving a first potential; a second potential input terminal for receiving a second potential; a pump cell group formed of a plurality of pump cells and connected in series between the first potential input terminal and the second potential input terminal; and a negative voltage boosting capacitor connected to a first connection node between the first potential input terminal and a forefront stage pump cell of the pump cell group. Each of the pump cells is configured to increase a boosted voltage using a transistor operating in synchronization with a clock signal input through a capacitor.

According to the present invention, the charge pump circuit is formed of one single circuit for generating both a positive boosted voltage and a negative boosted voltage. Further, the charge pump circuit includes the negative voltage boosting capacitor. Accordingly, it is possible minimize a boosted voltage difference between absolute values of the positive boosted voltage and the negative boosted voltage.

### BRIEF DESCRIPTION OF THE DRAWINGS

FIG. 1 is a block diagram showing a configuration of a charge pump circuit according to an embodiment of the present invention;

FIG. 2 is a time chart showing an operation of the charge pump circuit when a positive boosted voltage is generated according to the embodiment of the present invention; and

FIG. 3 is a time chart showing an operation of the charge pump circuit when a negative boosted voltage is generated according to the embodiment of the present invention.

### DETAILED DESCRIPTION OF PREFERRED EMBODIMENTS

Hereunder, preferred embodiments of the present invention will be explained with reference to the accompanying drawings.

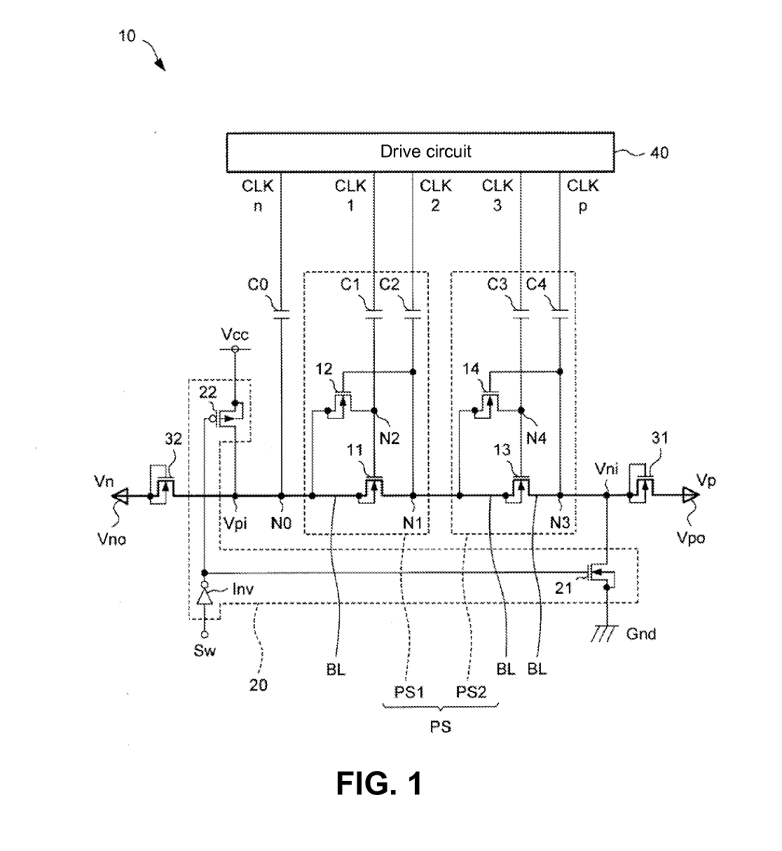

FIG. 1 is a block diagram showing a configuration of a charge pump circuit 10 according to an embodiment of the present invention.

As shown in FIG. 1, the charge pump circuit 10 includes a boost line BL having a first potential input terminal Vpi and a second potential input terminal Vni. The first potential input terminal Vpi is provided for inputting a first potential (for example, a power source potential Vcc). The second potential input terminal Vni is provided for inputting a second potential (for example, a ground potential Gnd). It should be noted that the first potential input terminal Vpi corresponds to a power source potential input terminal, and the second potential input terminal Vni corresponds to a ground potential input terminal.

In the embodiment, the charge pump circuit 10 further includes a pump cell group PS. The pump cell group PS is connected in series between the first potential input terminal Vpi and the second potential input terminal Vni, and is formed of a plurality of pump cells. More specifically, the pump cell group PS is formed of two pump cells, that is, a first pump cell PS1 and a second pump cell PS2.

In the embodiment, each of the first pump cell PS1 and the second pump cell PS2 is configured to perform a voltage boosting operation using a transistor that is operating in synchronization to a clock signal input through a capacitor. In the following description, in the pump cell group PS, the first pump cell PS1 situated at a closest position to the first potential input terminal Vpi is referred to as a first pump cell (or a forefront stage pump cell), and the second pump cell PS2 situated at a closest position to the second potential input terminal Vni is referred to as a first pump cell (or a last stage pump cell). Further, a connection node N0 of the boost line BL between the first potential input terminal Vpi and the first pump cell PS1 is referred to as a first connection node N0, and a connection node N3 of the boost line BL between the second potential input terminal Vni and the second pump cell PS2 is referred to as a second connection node N3.

In the embodiment, the boost line BL includes a first boosted potential output terminal Vpo and a second boosted potential output terminal Vno. The first boosted potential output terminal Vpo is connected to the second connection node N3, and the second boosted potential output terminal Vno is connected to the first connection node N0. It should be noted that the first boosted potential output terminal Vpo corresponds to a positive voltage output terminal, so that a boosted voltage Vp with a positive polarity (a positive boosted voltage Vp) is output from the first boosted potential output terminal Vpo. Similarly, the second boosted potential output terminal Vno corresponds to a negative voltage output terminal, so that a boosted voltage Vn with a negative polarity (a negative boosted voltage Vn) is output from the second boosted potential output terminal Vno.

In the embodiment, each of the pump cells of the pump cell group PS includes a first transistor; a second transistor; a first capacitor; and a second capacitor. The first transistor is connected in series to the first potential input terminal Vpi and the second potential input terminal Vni of the boost line BL. The second transistor is provided for connecting a gate of the first transistor to a drain of the first transistor. The first capacitor has one electrode connected to a source of the first transistor and a gate of the second transistor. The second capacitor has one electrode connected to the gate of the first transistor. The first capacitor has another electrode for receiving a first clock signal (a first input clock signal) having a specific phase. The second capacitor has another electrode for receiving a second clock signal (a second input clock signal) having a specific phase.

More specifically, the first pump cell PS1 includes an N-channel type MOSFET 11 (referred to as an NMOS 11) as the first transistor; an NMOS 12 as the second transistor; a capacitor C1 as the second capacitor; and a capacitor C2 as the first capacitor.

Further, a drain of the NMOS 11 is connected to the first potential input terminal Vpi and a drain of the NMOS 12 at the first connection node N0. Further, a source of the NMOS 11 is connected to a gate of the NMOS 12 and one end portion of the capacitor C2 at a connection node N1. Further, a source of the NMOS 12 is connected to a gate of the NMOS 11 and one end portion of the capacitor C1 at a connection node N2. The capacitor C1 has the other end portion for receiving a clock signal CLK1, and the capacitor C2 has the other end portion for receiving a clock signal CLK2.

In the embodiment, the second pump cell PS2 includes an NMOS 13 as the first transistor; an NMOS 14 as the second transistor; a capacitor C3 as the second capacitor; and a capacitor C4 as the first capacitor.

Further, a drain of the NMOS 13 is connected to the connection node N1 of the first pump cell PS1 and a drain of the NMOS 14. Further, a source of the NMOS 13 is connected to the second potential input terminal Vni, a gate of the NMOS 14, and one end portion of the capacitor C4 at the second connection node N3. Further, a source of the NMOS 14 is connected to a gate of the NMOS 13 and one end portion of the capacitor C3 at a connection node N4. The capacitor C3 has the other end portion for receiving a clock signal CLK3, and the capacitor C4 has the other end portion for receiving a second clock signal CLKp.

In the embodiment, the charge pump circuit 10 includes a switch circuit 20 for switching an input of the power source potential Vcc into the first potential input terminal Vpi and an input of the ground potential Gnd into the second potential input terminal Vni according to a single switching signal Sw. Further, the switch circuit 20 is configured to switch an operation between a positive voltage output mode or a negative voltage output mode. In the positive voltage output mode, the charge pump circuit 10 outputs the positive boosted voltage Vp through the boost line BL. In the negative voltage output mode, the charge pump circuit 10 outputs the negative boosted voltage Vn through the boost line BL. Further, the switch circuit 20 includes an NMOS 21; a P-channel type MOSFET 22 (referred to as a PMOS 22); and an inverter Inv.

In the embodiment, the inverter Inv has an input terminal for receiving the switching signal Sw from a control circuit (not shown), so that the output operation is switched between the positive boosted voltage Vp and the negative boosted voltage Vn. Further, the inverter Inv has an output terminal connected to the gate of the NMOS 21 and the gate of the PMOS 22. Accordingly, the inverter Inv is configured to supply a signal having a logic level inverted from that of the switching signal Sw to the gate of the NMOS 21 and the gate of the PMOS 22.

In the embodiment, the ground potential Gnd is applied to a drain of the NMOS 21, and a source of the NMOS 21 is connected to the second potential input terminal Vni (the second connection node N3). Further, the power source potential Vcc is applied to a drain of the PMOS 22, and a source of the PMOS 22 is connected to the first potential input terminal Vpi (the first connection node N0). As a result, the switch circuit 20 is configured to switch the positive voltage output mode and the negative voltage output mode of the charge pump circuit 10 based on the switching signal Sw that is one single signal. Accordingly, it is possible to prevent both the power source potential Vcc and the ground potential Gnd from being supplied to the boost line BL at the same time.

In the embodiment, when the switching signal Sw is at a high (H) level, the PMOS 22 of the switch circuit 20 becomes an on state, so that the power source potential Vcc is applied to the boost line BL. At this moment, the charge pump circuit 10 operates in the positive voltage output mode. On the other hand, when the switching signal Sw is at a low (L) level, the NMOS 21 of the switch circuit 20 becomes an on state, so that the ground potential Gnd is applied to the boost line BL. At this moment, the charge pump circuit 10 operates in the negative voltage output mode.

In the embodiment, the charge pump circuit 10 further includes a capacitor C0. One end portion of the capacitor C0 is connected to N0 between Vpi and PS1. The other end portion of the capacitor C0 is configured to receive a first clock signal CLKn. It should be noted that the capacitor C0 is configured to function as a negative voltage boosting capacitor. When the charge pump circuit 10 is provided with the capacitor C0, it is possible to increase the number of booster stages by one stage during the operation of boosting the negative voltage (the negative voltage output mode). In other words, when just the capacitor C0 is provided in the charge pump circuit 10, it is possible to minimize a difference in absolute values between the negative boosted voltage Vn and the positive boosted voltage Vp.

In the embodiment, when the ground potential Gnd (the second potential) is input into the second potential input terminal Vni, that is, when the charge pump circuit 10 operates in the negative voltage output mode, the capacitor C0 is configured to perform a charging-discharging operation.

In the embodiment, as described above, the first pump cell PS1, which is the last stage pump cell of the pump cell group PS, includes the capacitor C4 connected to the second connection node N3 between the second potential input terminal Vni and the second pump cell PS2. The capacitor C4 of the first pump cell PS1 as the last stage pump cell is configured to function as a positive voltage boosting capacitor. When the power source potential Vcc (the first potential) is input into the first potential input terminal Vpi, that is, when the charge pump circuit 10 operates in the positive voltage output mode, the capacitor C4 is configured to perform a charging-discharging operation.

In the embodiment, the charge pump circuit 10 further includes a drive circuit 40 for supplying the first clock signal CLKn to the capacitor C0 and the second clock signal CLKp to the capacitor C4. When the power source potential Vcc (the first potential) is input into the first potential input terminal Vpi, that is, when the charge pump circuit 10 operates in the positive voltage output mode, the drive circuit 40 stops supplying the first clock signal CLKn to the capacitor C0. In other words, when the power source potential Vcc (the first potential) is input into the first potential input terminal Vpi, the ground potential Gnd is applied to the capacitor C0 all the time. Accordingly, when the charge pump circuit 10 operates in the positive voltage output mode, the capacitor C0 does not perform the charging-discharging operation.

Further, when the ground potential Gnd (the second potential) is input into the second potential input terminal Vni, that is, when the charge pump circuit 10 operates in the negative voltage output mode, the drive circuit 40 stops supplying the second clock signal CLKp to the capacitor C4. In other words, when the ground potential Gnd (the second potential) is input into the second potential input terminal Vni, the ground potential Gnd is applied to the capacitor C4 all the time. Accordingly, when the charge pump circuit 10 operates in the negative voltage output mode, the capacitor C4 does not perform the charging-discharging operation. When the drive circuit 40 performs the operations described above, it is possible to prevent an adverse effect relative to the voltage boosting operation such as generation of a power source noise, a fluctuation in the boosted voltage, and the like. As a result, it is possible to stably output the boosted voltage at an ideal level. It should be noted that the drive circuit 40 is configured to supply clock signals CLK1 to CLK3 to the capacitor C1, the capacitor C2, and the capacitor C3, respectively, in addition to the capacitor C0 and the capacitor C4 as the negative voltage boosting capacitor and the positive voltage boosting capacitor.

In the embodiment, the charge pump circuit 10 further includes an NMOS 31 and an NMOS 32 connected in a diode configuration, and the NMOS 31 and the NMOS 32 are disposed between the first boosted potential output terminal Vpo and N3 of the boost line BL, and between the second boosted potential output terminal Vno and the first connection node N0 of the boost line BL. More specifically, the gate and the drain of the NMOS 31 are connected to the second connection node N3, and the source of the NMOS 31 is connected to the first boosted potential output terminal Vpo. Further, the gate and the drain of the NMOS 32 are connected to the second boosted potential output terminal Vno, and the source of the NMOS 32 is connected to the first connection node N0. Accordingly, the NMOS 31 and the NMOS 32 connected in the diode configuration are configured to have a function of preventing an electrical current from flowing backward from a load circuit (not shown) connected to the first boosted potential output terminal Vpo and the second boosted potential output terminal Vno. In other words, the NMOS 31 and the NMOS 32 are configured to prevent the voltage value of the boosted voltage output from the charge pump circuit 10 from being fluctuated, thereby making it possible to output the boosted voltage having an ideal voltage value.

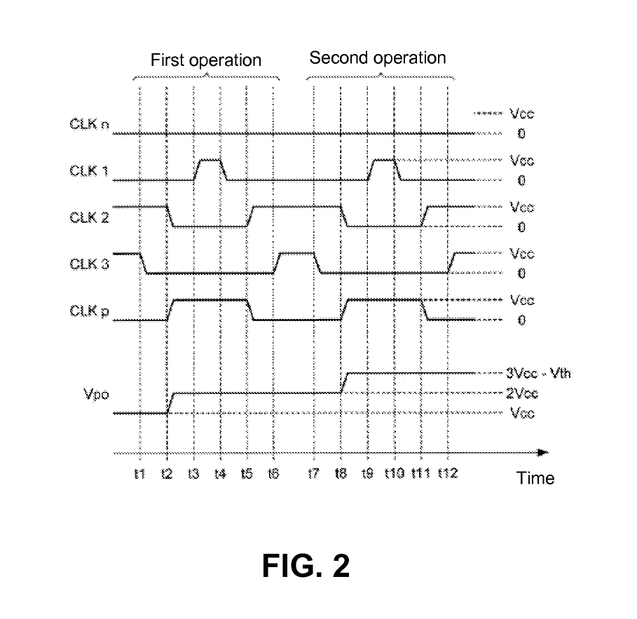

An operation of the charge pump circuit 10 in the positive voltage output mode will be explained with reference to FIG. 2. FIG. 2 is a time chart showing the operation of the charge pump circuit 10 when the positive boosted voltage Vp is generated according to the embodiment of the present invention. FIG. 2 shows transitional states of the clock signals input from the drive circuit 40 into the capacitors C0 to C4 and the voltage level of the positive boosted voltage Vp output from the first boosted potential output terminal Vpo. It should be noted that the vertical axis in FIG. 2 represents a potential level, and the horizontal axis in FIG. 2 represents time.

As a preparation step before the operation, the switching signal Sw with the high (H) level is input into the inverter Inv of the switch circuit 20, so that the PMOS 22 of the switch circuit 20 becomes the on state and the NMOS 21 of the switch circuit 20 becomes the off state. Further, the clock signal CLK2 and the clock signal CLK3 are set to have the potential level equal to the power source potential Vcc.

As shown in FIG. 2, in the positive voltage output mode, the drive circuit 40 stops supplying the first clock signal CLKn. Accordingly, the potential having the low (L) level, that is, the ground potential Gnd, is applied to the capacitor C0 all the time. As a result, the capacitor C0 does not perform the charging-discharging operation. In the following description, when the clock signal is raised, that means the potential level of the clock signal is changed from the ground potential Gnd (that is, zero) to the power source potential Vcc. Similarly, when the clock signal is dropped, that means the potential level of the clock signal is changed from the power source potential Vcc to the ground potential Gnd.

As shown in FIG. 2, at a timing t1, the clock signal CLK3 is dropped, so that the NMOS 13 becomes the off state. At a timing t2, the second clock signal CLKp is raised, so that the gate voltage of the NMOS 14 is boosted to supply electric charges to the gate of the NMOS 13. Further, the clock signal CLK2 is raised, so that the NMOS 12 becomes the off state. At a timing t3, the clock signal CLK1 is raised, so that the gate voltage of the NMOS 11 is boosted greater than a sum of the power source potential Vcc and a threshold voltage Vth of the NMOS 11. Accordingly, the NMOS 11 becomes the on state.

At a timing t4, the clock signal CLK1 is dropped, so that the NMOS 11 becomes the off state. At a timing t5, the clock signal CLK2 is raised, and the second clock signal CLKp is dropped. At a timing t6, the clock signal CLK3 is raised, so that a boosted voltage 2 Vcc is transmitted to the second pump cell PS2 at the next stage without any voltage decline due to the threshold voltage Vth. As described above, through the operation from the timing t1 to the timing t6, the charge pump circuit 10 performs the first operation of boosting the positive voltage.

In the embodiment, when the charge pump circuit 10 repeats the operation from the timing t1 to the timing t6 in an operation from a timing t7 to a timing t12, the charge pump circuit 10 performs the second operation of boosting the positive voltage. In the second operation, the first pump cell PS1 boosts the positive voltage to a level double of the power source potential Vcc without any voltage decline due to the threshold voltage Vth of the NMOS 11.

In the embodiment, it should be noted that the charge pump circuit 10 outputs the positive boosted voltage Vp as the output voltage from the first boosted potential output terminal Vpo, and the positive boosted voltage Vp is a difference between the positive boosted voltage of the pump cell group PS and the threshold voltage Vth of the NMOS 31 of the boost line BL. Accordingly, when the charge pump circuit 10 performs the operation in the positive voltage output mode, the positive boosted voltage Vp at the first boosted potential output terminal Vpo is equal to 2 Vcc−Vth in the first operation, and 3 Vcc−Vth in the second operation as shown in FIG. 2.

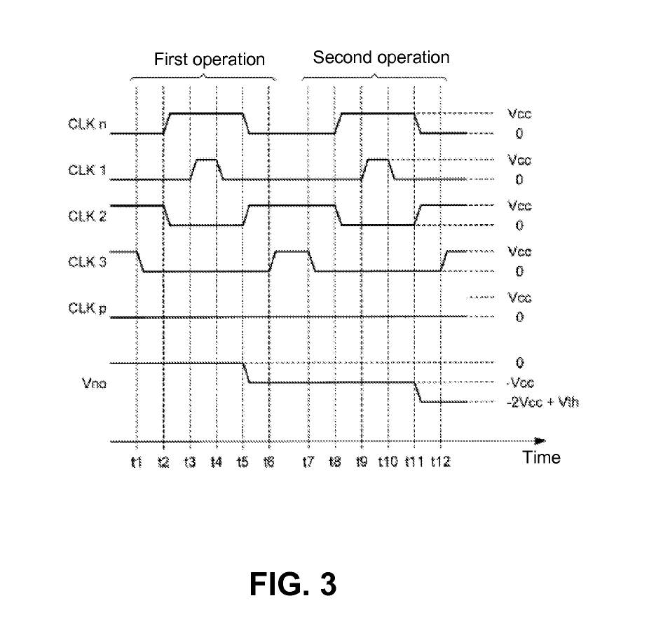

An operation of the charge pump circuit 10 in the negative voltage output mode will be explained with reference to FIG. 3. FIG. 3 is a time chart showing the operation of the charge pump circuit 10 when the negative boosted voltage Vn is generated according to the embodiment of the present invention. FIG. 3 shows transitional states of the clock signals input from the drive circuit 40 into the capacitors C0 to C4 and the voltage level of the negative boosted voltage Vn output from the second boosted potential output terminal Vno. It should be noted that the vertical axis in FIG. 3 represents a potential level, and the horizontal axis in FIG. 3 represents time.

As a preparation step before the operation, the switching signal Sw with the low (L) level is input into the inverter Inv of the switch circuit 20, so that the NMOS 21 of the switch circuit 20 becomes the on state and the PMOS 22 of the switch circuit 20 becomes the off state. Further, the clock signal CLK2 and the clock signal CLK3 are raised.

As shown in FIG. 3, in the negative voltage output mode, the drive circuit 40 stops supplying the second clock signal CLKp. Accordingly, the potential having the low (L) level, that is, the ground potential Gnd, is applied to the capacitor C4 all the time. As a result, the capacitor C4 does not perform the charging-discharging operation.

As shown in FIG. 3, just before the timing t1, the clock signal CLK3 is raised, so that the NMOS 13 becomes the on state. At the timing t1, the clock signal CLK3 is dropped, so that the NMOS 13 becomes the off state. At the timing t2, the first clock signal CLKn is raised, and the clock signal CLK2 is dropped. At the timing t3, the clock signal CLK1 is raised, so that the gate voltage of the NMOS 11 is boosted greater than the threshold voltage Vth of the NMOS 11. Accordingly, the NMOS 11 becomes the on state.

At the timing t4, the clock signal CLK1 is dropped, so that the NMOS 11 becomes the off state. At the timing t5, the first clock signal CLKn is dropped, so that the voltage is boosted to the negative potential level −Vcc. Further, the clock signal CLK2 is raised, so that the NMOS 12 becomes the on state. Accordingly, electrical charges are pulled out from the gate of the NMOS 11. At the timing t6, the clock signal CLK3 is raised. As described above, through the operation from the timing t1 to the timing t6, the charge pump circuit 10 performs the first operation of boosting the negative voltage.

In the embodiment, when the charge pump circuit 10 repeats the operation from the timing t1 to the timing t6 in an operation from the timing t7 to the timing t12, the charge pump circuit 10 performs the second operation of boosting the negative voltage. In the second operation, the capacitor C2, the capacitor C3, the NMOS 11, the NMOS 12, the NMOS 13, and the NMOS 14 boost the negative voltage to a negative level of the power source potential Vcc (−Vcc) without any voltage decline due to the threshold voltage Vth of the NMOS 11.

In the embodiment, it should be noted that the charge pump circuit 10 outputs the negative boosted voltage Vn as the output voltage from the second boosted potential output terminal Vno, and the negative boosted voltage Vn is a difference between the negative boosted voltage of the pump cell group PS and the capacitor C0 and the threshold voltage Vth of the NMOS 32 of the boost line BL in the positive direction. Accordingly, when the charge pump circuit 10 performs the operation in the negative voltage output mode, the negative boosted voltage Vn at the second boosted potential output terminal Vno becomes equal to −Vcc+Vth in the first operation, and −2 Vcc+Vth in the second operation as shown in FIG. 3.

As described above, in the embodiment of the present invention, the charge pump circuit 10 has the configuration shown in FIG. 1, so that the charge pump circuit 10 is capable of generating the voltage of 3 Vcc−Vth as the positive boosted voltage Vp and the voltage of −2 Vcc+Vth as the negative boosted voltage Vn. Accordingly, the difference in the absolute values of the voltage between the positive boosted voltage Vp and the negative boosted voltage Vn output from the charge pump circuit 10 becomes about Vcc, which is smaller than that of the conventional charge pump circuit.

In the embodiment, the charge pump circuit 10 includes the pump cell group PS formed of the two pump cells, that is, the first pump cell PS1 and the second pump cell PS2. Alternatively, the pump cell group PS may be formed of more than three pump cells. More specifically, more than one pump cells as a third pump cell may be disposed between the first pump cell PS1 at the forefront stage and the second pump cell PS2 at the last stage. It should be noted that the number of the pump cells may be determined according to a capacity of a capacitor of a pump cell, a voltage value necessary for a circuit design, and the like. It also should be noted that, regardless of the number of the pump cells, the difference in the absolute values of the voltage between the positive boosted voltage Vp and the negative boosted voltage Vn output from the charge pump circuit 10 becomes about Vcc, which is smaller than that of the conventional charge pump circuit.

In the embodiment, the first pump cell PS1 and the second pump cell PS2 have the configuration described above as an example. Alternatively, the first pump cell PS1 and the second pump cell PS2 may have a configuration capable of performing a desirable voltage boosting operation through using a transistor operating in synchronization to a clock signal input through a capacitor.

As described above, in the embodiment of the present invention, the charge pump circuit 10 is configured to output the positive boosted voltage Vp and the negative boosted voltage Vn alternately switched with the switch circuit 20. Further, the charge pump circuit 10 includes the capacitor C0 as the negative voltage boosting capacitor connected to the first connection node N0 between the first potential input terminal Vpi and the first pump cell PS1 at the forefront stage. Accordingly, with the addition of the capacitor C0 as the minimum configuration element, it is possible to boost the negative voltage by one more stage within the charge pump circuit 10. As a result, it is possible to minimize the difference in the absolute value of the voltage between the positive boosted voltage Vp and the negative boosted voltage Vn output from the charge pump circuit 10. Further, it is possible to stably obtain both the positive boosted voltage Vp and the negative boosted voltage Vn at the desirable level with the one charge pump circuit.

The disclosure of Japanese Patent Application No. 2014-014385, filed on Jan. 29, 2014, is incorporated in the application by reference.

While the invention has been explained with reference to the specific embodiments of the invention, the explanation is illustrative and the invention is limited only by the appended claims.

What is claimed is:

1. A charge pump circuit, comprising:
a first potential input terminal for receiving a first potential;
a second potential input terminal for receiving a second potential;
a pump cell group connected in series between the first potential input terminal and the second potential input terminal, said pump cell including a first pump cell and a second pump cell, said first pump cell being connected at a forefront stage of the pump cell group; and
a negative voltage boosting capacitor connected to a first connection node between the first potential input terminal and the first pump cell,
wherein each of said first pump cell and said second pump cell includes a first transistor and a second transistor operating according to a first clock signal and a second clock signal.

2. The charge pump circuit according to claim 1, wherein said second pump cell is connected at a last stage of the pump cell group,
said second pump cell includes a positive voltage boosting capacitor connected to a second connection node between the second potential input terminal and the second pump cell,
said positive voltage boosting capacitor is configured to perform a first charging-discharging operation when the first potential is input into the first potential input terminal, and
said negative voltage boosting capacitor is configured to perform a second charging-discharging operation when the second potential is input into the second potential input terminal.

3. The charge pump circuit according to claim 2, further comprising a drive circuit configure to supply the first clock signal to the negative voltage boosting capacitor and the second clock signal to the positive voltage boosting capacitor,
said drive circuit is configure to stop supplying the first clock signal to the negative voltage boosting capacitor when the first potential is input into the first potential input terminal, and.
said drive circuit is configure to stop supplying the second clock signal to the positive voltage boosting capacitor when the second potential is input into the second potential input terminal.

4. The charge pump circuit according to claim 4, wherein said first pump cell further includes the first transistor connected in series between the first potential input terminal and the second potential input terminal,
said first pump cell further includes the second transistor connected between a gate of the first transistor and a drain of the first transistor,
said first pump cell further includes a first capacitor having one end portion connected to a source of the first transistor and a gate of the second transistor,
said first capacitor has the other end portion for receiving the first clock signal,
said first pump cell further includes a second capacitor having one end portion connected to the gate of the first transistor, and
said second capacitor has the other end portion for receiving the second clock signal.

5. The charge pump circuit according to claim 2, further comprising:
a first boosted voltage output terminal connected to the second connection node;
a second boosted voltage output terminal connected to the first connection node;
a first N-channel type MOSFET disposed between the first boosted voltage output terminal and the second connection node; and
a second N-channel type MOSFET disposed between the second boosted voltage output terminal and the first connection node,
wherein each of said first N-channel type MOSFET and said second N-channel type MOSFET is connected in a diode configuration.

6. The charge pump circuit according to claim 1, further comprising a switch circuit for switching the first potential and the second potential according to one single switching signal.

7. The charge pump circuit according to claim 1, wherein said first potential input terminal is configured to receive the first potential equal to a power source potential,
said second potential input terminal is configured to receive the second potential equal to a ground potential,
said first boosted voltage output terminal is configured to output a boosted voltage having a positive polarity, and
said second boosted voltage output terminal is configured to output a boosted voltage having a negative polarity.
